(19) United States
(12) Patent Application Publication
(10) Pub. No.: US 2008/0097689 A1
(43) Pub. Date: Apr. 24, 2008

(54) AN INFORMATION APPARATUS FOR AN OPERATOR OF A LAND OR WATER BASED MOTOR DRIVEN CONVEYANCE

(75) Inventors: George Germanos, New South Wales (AU); Henry Setiawan, New South Wales (AU)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: Speedalert PTY LTD, New South Wales (AU)

(21) Appl. No.: 11/573,163

(22) PCT Filed: Aug. 4, 2005
(86) PCT No.: PCT/AU05/01164

§ 371 Date: Feb. 2, 2007

(30) Foreign Application Priority Data
Aug. 4, 2004 (AU) 2004904330

(51) Int. Cl. G01C 21/00; G01S 5/00

(52) U.S. Cl. 701/206

(57) ABSTRACT

An information system (1) including an input (2) for receiving data (5) indicative of one or more consecutive identifiers such a pair of consecutive identifiers (6) and (7) or an individual identifier (8). Each identifier (6) to (8) includes data (9) indicative of at least one geographical waypoint. A processor (10) is responsive to data (5) for defining for each identifier (6) to (9) a respective polygon indicative of a geographical region. This occurs such that any given geographical position within the polygon is associated with the defining identifier In the present embodiment, each polygon has one or more characteristics and the defining identifier includes data indicative of those characteristics.

### FIELD OF THE INVENTION

The present invention relates to an information system.

The invention has been primarily developed for the collection, storage, processing and interrogation of geographical information, and will be described herein with reference s to those applications. However, it will be appreciated that the invention is not limited to those particular fields of use.

### BACKGROUND TO THE INVENTION

Any discussion of the prior art throughout the specification should in no way be considered as an admission that such prior art is widely known or forms part of common to general knowledge in the field.

It is known to maintain a portable database of geographical information. Typically, such a database is stored on a hand-held or in-car device, and used in conjunction with a GPS module to provide location specific information. A common example is an in-car navigation system.

Known databases often require hundreds of megabytes of storage space to allow the display to the user of a map containing indicia of streets, bridges, other landmarks and likely items of interest. The large data storage needs of such a map limits the use of navigation systems given the typical storage capacity of known hand-held devices, such as PDAs and cellular telephones (also known as mobile telephones). Moreover, as the resolution of the map is increased, or as additional points of interest or other details are included, not only does the size of the database increase, but typically so too does the time taken to query the database to retrieve the desire information. The modest processing capacity available to PDAs and other portable devices tends to exacerbate this problem.

### SUMMARY OF THE INVENTION

It is an object of the present invention to overcome or ameliorate at least one of the disadvantages of the prior art, or to provide a useful alternative.

In accordance with a first aspect, there is provided an information system including:
an input for receiving data indicative of one or more consecutive identifiers, each identifier including data indicative of at least one geographical waypoint; and
a processor responsive to the data for defining for each identifier a respective polygon indicative of a geographical region such that any given s geographical position within the polygon is associated with the defining identifier.

Preferably, each polygon has one or more characteristics and the defining identifier includes data indicative of the one or more characteristics.

Preferably, the data is indicative of a first identifier indicative of a first waypoint and a consecutive second identifier indicative of a second waypoint, and the processor defines for the first identifier a directional polygon extending between the first and second waypoints.

Preferably, the directional polygon has an axis of symmetry connecting the fist and second waypoints.

Preferably, the directional polygon is a rectangle having opposite edges passing through the first and second waypoints.

Preferably, the processor is responsive to the first identifier for assigning a width to the rectangle.

Preferably, the data is further indicative of a third identifier that is consecutive to the second identifier, and the processor defines for the second identifier a directional polygon extending between the second and third waypoints.

Preferably, two or more adjacent directional polygons define a track.

Preferably, consecutive identifiers include data indicative of waypoints located along a directional passageway to such that the processor generates a track indicative of the passageway.

Preferably, an identifier is provided for each geographical position along the passageway where the passageway undergoes greater than a threshold angular deviation.

Preferably, the data includes a single identifier indicative of three or more waypoints and the processor defines an areal polygon having a periphery defined by the three or more waypoints.

Preferably, the data includes an identifier indicative of three or more consecutively arranged waypoints including an originating waypoint and a terminating waypoint, and the processor defines an areal polygon having sides extending between consecutive waypoints and a side extending between the originating waypoint and the terminating waypoint.

Preferably the system includes including an interface for receiving data indicative of a geographical position, the interface being in communication with processor for:
determining whether the geographical position is located within a defined polygon; and
where the geographical position is located within a defined polygon, obtaining data indicative of the one or more characteristics of the defining identifier.

Preferably, the interface receives data indicative of a geographical position from a GPS module. (Triangulation with mobile telephone system)

Preferably the system includes an output for providing a signal indicative of one or more of the obtained characteristics.

Preferably, the characteristics include any one or more of the following:

a speed limit;

an upcoming speed limit;

an object;

an upcoming object;

region-specific advertising,

a geographical name; and

a street name.

Preferably, one or more of the characteristics are variable with time.

According to a second aspect of the invention, there is provided a system for logging geographical information, the system including:
a data logger for defining one or more consecutive identifiers, each identifier including data indicative of at least one geographical waypoint the identifiers being processable to define for each identifier a respective polygon indicative of a geographical region such that any given geographical position within the polygon is associated with the defining identifier.

According to a third aspect of the invention, there is provided a method for logging geographical information including the steps of:
consecutively logging one or more geographical waypoints; and
generating one or more identifier including data indicative of the one or more geographical waypoints such that the identifiers are processable to define for each identifier a respective polygon indicative of a geographical region such that any given geographical position within-the polygon is associated with the defining identifier.

According to a fourth aspect of the invention, there is provided a system for storing information, the system including:
a database for receiving and storing one or more consecutive identifiers, each identifier including data indicative of at least one geographical waypoint the identifiers being processable to define for each identifier a respective polygon indicative of a geographical region such that any given geographical position within the polygon is associated with the defining identifier.

In a further aspect, the invention provides an information apparatus for an operator of a land or water based motor driven conveyance such as a motor vehicle, locomotive, tram, or water vessel including:

a means of retrieving selective information from a database of information that applies to a conveyance according to its instant position and its instant direction as it moves along a passageway;

a means of determining the instant position of the conveyance and determining the instant direction the conveyance is moving;

a means of communicating to the operator information retrieved as a result of the determined instant position and instant direction of the conveyance;

a means of alerting the operator when the retrieved information changes due to movement of the conveyance.

Preferably the database of information includes records of legal or safety speed limits that apply to the conveyance moving along a passageway, and the information retrieved includes the instant speed limit that applies to the conveyance.

Preferably the information retrieved includes an upcoming speed limit that may apply to the conveyance travelling on the passageway that is less than the instant speed limit. Alternatively the information retrieved includes an upcoming speed limit that may apply to the conveyance travelling on the passageway that is different to the instant speed limit.

Preferably at least some of the speed limit records are compiled by logging at least the latitudinal and longitudinal coordinates of speed limit waypoints along a passageway, and with each speed limit waypoint logging:

a corresponding speed limit;

s at least the latitudinal and longitudinal coordinates of a corresponding directional waypoint wherein the directional waypoint is a designated minimum distance from the speed limit waypoint and in a direction along the passageway that a conveyance travels;

a direction reference calculated from each corresponding pair of speed limit and directional waypoints wherein the direction reference includes a designated maximum angular tolerance relative to the absolute direction from the speed limit waypoint to the corresponding directional waypoint;

at least the latitudinal and longitudinal coordinates of the nodes of a speed limit direction polygon that is symmetrical and wherein:

the area encompassed by the direction polygon is representative of and includes at least a portion of the area of the passageway between the speed limit waypoint and at least one other speed limit waypoint; and

the axis of symmetry is substantially parallel to or coincident with a linear line extending between the speed limit waypoint and the at least one other speed limit waypoint.

Preferably with each speed limit waypoint in the speed limit records a speed limit warning zone is logged wherein:

the corresponding speed limit waypoint is within or on the boundary of the area encompassed by the warning zone, and

at least a portion of the area encompassed by the warning zone is representative of and includes at least a portion of the area of the passageway on approach to the speed limit waypoint along the passageway.

Preferably at least some of the speed limit records are compiled by logging records of at least the latitudinal and longitudinal coordinates of the nodes of speed limit area polygons and a corresponding speed limit for each area polygon wherein the area encompassed by each polygon is representative of and includes the area of a plurality of passageways having a common speed limit.

Preferably the instant speed limit communicated to the operator is determined by determining at least the instant latitude and longitude position of the conveyance and determining the instant direction the conveyance is moving and:

if the determined at least the instant latitude and longitude position is within the area encompassed by a speed limit direction polygon and the instant direction is within the direction reference corresponding with the speed limit waypoint that corresponds with the speed limit direction polygon then the speed limit communicated to the operator is the speed limit corresponding to the speed limit waypoint; otherwise

if the determined at least the instant latitude and longitude position is within. the area encompassed by a speed limit area polygon then the speed limit communicated to the operator is the speed limit corresponding to the speed limit area polygon; otherwise a default message is communicated instead of the instant speed limit.

Preferably the instant speed limit warning communicated to the operator is determined by determining if the at least the instant latitude and longitude position of the conveyance is within the area encompassed by a warning zone and:

if the determined at least the instant latitude and longitude position is within the area encompassed by a warning zone then the speed limit warning communicated to the operator is the speed limit corresponding to the speed limit waypoint corresponding to the warning zone; otherwise

nothing is communicated or a default message is communicated.

Preferably an operator alert event is initiated when the communicated instant speed limit changes as a result of movement of the conveyance.

Preferably an operator alert event is initiated when the communicated speed limit warning changes as a result of movement of the conveyance.

Preferably the operator alert event includes the sounding of an audible signal.

Preferably at least some of the speed limit waypoints and corresponding directional waypoints are logged by:

cooperatively interconnecting a global positioning receiver to a data acquisition apparatus so that the instant global position information including the instant latitude and longitude position indicated by the receiver can on demand be logged on the data acquisition apparatus;

travelling with the global positioning receiver along a passageway and when a speed limit indicator is encountered along the passageway commanding the data acquisition apparatus to sample and log the instant global position information including the instant latitude and longitude position indicated by the receiver creating a speed limit waypoint while continuing with the travel;

data inputting into the data acquisition apparatus against the speed limit waypoint at least the speed limit indicated by the speed limit indicator;

allowing the data acquisition apparatus to automatically sample the instant global position information including the instant latitude and longitude position indicated by the receiver after a set time from when the speed limit waypoint was sampled, and log the second sampled global position information including the latitude and longitude position as a direction waypoint associated with the speed limit waypoint.

In a still further aspect the invention provides an information apparatus for an operator of a land or water based motor driven conveyance such as a motor vehicle, locomotive, tram, or water vessel including:

a means of retrieving selective information from a database of information that applies to a conveyance according to its instant position and instant direction it moves along a passageway and at least one of, time, or date it is moving;

a means of determining the instant position of the conveyance and determining the instant direction the conveyance is moving and determining at least one of the instant time, day or date at the time of determining the position or direction;

a means of communicating to the operator information retrieved as a result of the determined instant position and instant direction of the conveyance and at least one of the determined time, day or date;

a means of alerting the operator when the retrieved information changes due to movement of the conveyance or at least one of a change in time, day or date.

Preferably the database of information includes records of legal or safety speed limits that apply to a conveyance moving along a passageway at a particular time, and or on a particular day and or on a particular date, and the information retrieved includes the instant speed limit that applies to the conveyance.

Preferably the information retrieved includes an upcoming speed limit that may apply to the conveyance traveling on the passageway that is less than the instant speed limit. Alternatively the information retrieved includes an upcoming speed limit that may apply to the conveyance traveling on the passageway that is different to the instant speed limit.

Preferably at least some of the speed limit records are compiled by logging at least s the latitudinal and longitudinal coordinates of speed limit waypoints along a passageway and with each speed limit waypoint logging:

a corresponding speed limit that applies for specified times, days, and dates or any combination of these;

at least the latitudinal and longitudinal coordinates of a corresponding directional. waypoint wherein the directional waypoint is a designated minimum distance from the speed limit waypoint and in a direction along the passageway that a conveyance travels;

a direction reference calculated from each corresponding pair of speed limit and directional waypoints wherein the direction reference includes a designated maximum angular tolerance relative to the absolute direction from the speed limit waypoint to the corresponding directional waypoint;

at least the latitudinal and longitudinal coordinates of the nodes of a speed limit direction polygon that is symmetrical and wherein:

the area encompassed by the polygon is representative of and includes at least a portion of the area of the passageway between the speed limit waypoint and at least one other speed limit waypoint; and

the axis of symmetry is substantially parallel to or coincident with a linear line extending between the speed limit waypoint and the at least one other speed limit waypoint.

Preferably with each speed limit waypoint in the speed limit records a speed limit warning zone is logged wherein:

the corresponding speed limit waypoint is within or on the boundary of the area encompassed by the warning zone, and

at least a portion of the area encompassed by the warning zone is representative of and includes at least a portion of the area of the passageway on approach to the speed limit waypoint along the passageway.

Preferably at least some of the speed limit records in the database are compiled by logging records of at least the latitudinal and longitudinal coordinates of the nodes of speed limit area polygons and a corresponding speed limit for each speed limit polygon wherein the area encompassed each polygon is representative of and includes the area of a plurality of passageways having a common speed limit at least for a minimum instant time, day or date duration.

Preferably the instant speed limit communicated to the operator is determined by determining at least the instant latitude and longitude position of the conveyance and determining the instant direction the conveyance is moving and determining the instant time, day and date:

if the determined at least the instant latitude and longitude position is within the area encompassed by a speed limit direction polygon and the instant direction is within the direction reference corresponding with the speed limit waypoint that corresponds with the speed limit direction polygon then the speed limit communicated to the operator is the speed limit corresponding to the speed limit waypoint that applies for the instant time, day or date or any combination of these; otherwise

if the determined at least the instant latitude and longitude position is within the area encompassed by a speed limit area polygon then the speed limit communicated to the operator is the speed limit corresponding to the speed limit area polygon; otherwise a default message is communicated instead of the instant speed limit.

Preferably the instant speed limit warning communicated to the operator is determined by determining if the at least the instant latitude and longitude position of the conveyance is within the area encompassed by a warning zone and:

if the determined at least the instant latitude and longitude position is within the area encompassed by a warning zone then the speed limit warning communicated to the operator is the speed limit corresponding to the speed limit waypoint corresponding to the warning zone; otherwise

nothing is communicated or a default message is communicated.

Preferably an operator alert event is initiated when the communicated instant speed limit changes as a result of movement of the conveyance or a change in time, day or date.

Preferably an operator alert event is initiated when the communicated speed limit warning changes as a result of movement of the conveyance or a change in time, day or date.

Preferably the operator alert event includes the sounding of an audible signal.

Preferably at least some of the speed limit waypoints and corresponding directional waypoints are logged by:

cooperatively interconnecting a global positioning receiver to a data acquisition apparatus so that the instant global position information including the instant latitude and longitude position indicated by the receiver can on demand be logged on the data acquisition apparatus;

travelling with the global positioning receiver along a passageway and when a speed limit indicator is encountered along the passageway commanding the data acquisition apparatus to sample and log the instant global position information including the instant latitude and longitude position indicated by the receiver creating a speed limit waypoint while continuing with the travel;

data inputting into the data acquisition apparatus against the speed limit waypoint at least the speed limit indicated by the speed limit indicator and the corresponding times, and or days and or dates the speed limit applies;
allowing the data acquisition apparatus to automatically sample the instant global position information including the instant latitude and longitude position indicated by the receiver after a set time from when the speed limit waypoint was sampled, and log the second sampled global position information including the latitude and longitude position as a direction waypoint associated with the speed limit waypoint.

### BRIEF DESCRIPTION OF THE DRAWINGS

Preferred embodiments of the invention will now be described, by way of example only, with reference to the accompanying drawings in which:

FIG. 1 is a schematic representation of an information system according to the invention;

FIGS. 2 to 9 schematically illustrate exemplary polygons for use in conjunction with the system of FIG. 1;

FIG. 10 schematically illustrates an implementation of the system of FIG. 1;

FIG. 11 schematically illustrates the operation of a OPS module;

FIG. 11 schematically illustrates the operation of a device utilising the system of FIG. 1;

FIG. 13 schematically illustrates a cluster, cells, waypoints and polygons;

FIG. 14 is a schematic representation of a road system;

FIG. 15 is a representation of a digital map based on the road system of FIG. 14;

FIG. 16 illustrates a schematic portion of a road network partially mapped with s speed limit direction polygons and speed limit warning zones in accordance with a preferred embodiment of the invention;

FIG. 17 illustrates a schematic portion of a road network partially mapped with speed limit direction polygons, speed limit warning zones, and speed limit area polygons in accordance with a preferred embodiment of the invention;

FIG. 18 illustrates a portion of the road network illustrated in FIG. 1 partially. mapped with a speed limit direction polygon and speed limit warning zone in accordance with a preferred embodiment of the invention.

### DETAILED DESCRIPTION

The disclosure herein incorporates by cross-reference the disclosure of Australian is provisional patent application 2004904330, filed Aug. 4, 2004.

Referring to the drawings, it will be appreciated that, in the different figures, corresponding features have been denoted by corresponding reference numerals.

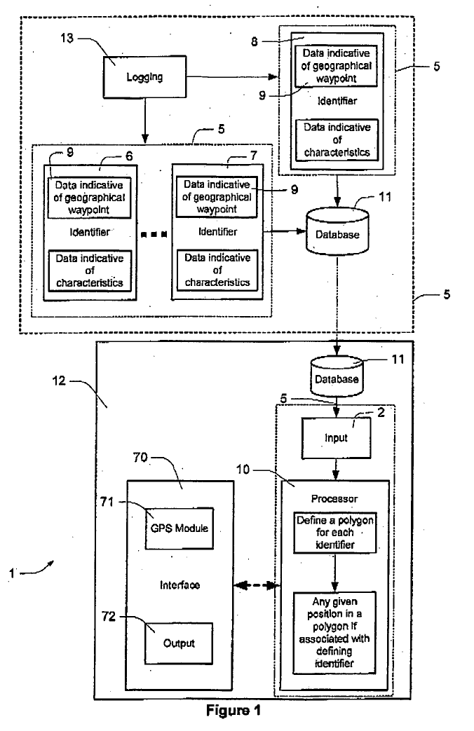

Referring initially to FIG. 1, there is provided an information system 1 including an input 2 for receiving data 5 indicative of one or more consecutive identifiers. FIG. 1 illustrates a pair of consecutive identifiers 6 and 7, as well as an isolated identifier 8. Each identifier 6 to 8 includes data 9 indicative of at least one geographical waypoint. A processor 10 is responsive to data 5 for defining for each identifier 6 to 8 a respective polygon indicative of a geographical region. This occurs such that any given geographical position within the polygon is associated with the defining identifier. In the present embodiment, each polygon has one or more characteristics and the defining identifier includes data indicative of those characteristics.

FIG. 1 illustrates a process whereby data 5 is logged and stored in a database 11. Database 11 is then uploaded via input 2 to a device 12, such as a mobile phone, PDA, or other suitable consumer electrical device. In the present embodiment, database 11 is reproduced in the internal memory of device 12. Processor 10 is integrated into device 12 and includes either or both of hardware and software components. Device 12 and alternate embodiments of device 12 are discussed in greater detail further below.

In the present embodiment, data 5 indicative of identifiers 6 to 8 is captured using a data logger 13. The general notion of the described embodiments is that database 11 is maintained at a relatively small file storage size compared with known databases designed for similar uses. To achieve this, logger 13 logs identifiers in accordance with a minimalist approach. An identifier is indicative of a waypoint—or set of waypoints—that marks a geographical location. An identifier is also indicative of a set of conditions that apply in a region covered by that waypoint or set of waypoints. Processor 10 uses data 5 to extrapolate the region for a given waypoint, which is defined in terms of a polygon.

It will be recognised that the described approach allows spatial regions to be effectively defined in database 11 using only a small number of coordinates. It will further be appreciated that coordinate based information has>in the past, typically requires a large amount of storage space in a database.

Database 11 is shown to be reproduced in device 12. In some embodiments database 11 is stored remotely of device 12 and accessed by a wireless communications link such as GPRS or a wireless internet protocol. It will be recognised that the present disclosure teaches techniques for maintaining database 11 at a relatively small size, particularly by comparison to known databases used for similar purposes. As such, database 11 is able to be communicated to device 12 using a number of communication protocols. Further, the small size increases the chances that database 11 is storable on internal memory of device 12.

Once database 11 is accessed by processor 10, the included data is expanded to generate polygons. In some embodiments the entire database is expanded concurrently, while in other embodiments only relevant portions are expanded at any one time. For example: using a streaming process that expands portions indicative of geographical regions proximal device 12 or approaching in a direction of travel experienced by device 12. Processor 10 acts in a manner similar to a database, in that it is queried on the basis of expanded data. In alternate embodiments processor 10 expands database 11 into polygon, and exports this expanded data to a further database.

Database 11 is updated periodically to better ensure that the contained information is current. There are two sides to this: firstly logging or updating logged information; and secondly updating database 11 as stored on device 12. The first side is carried out using various forms of data entry, and is of less interest. The second side of updating is typically performed by way of a “delta update”. That is, only information relating to changes need be communicated. Such an update is likely to involve a minimal amount of data, and is conveniently achieved using GPRS or the like. In some embodiments updates are proactively obtained, whilst in other embodiments they are automatically provided.

For the purpose of this specification, the term polygon is used in a conceptual sense, and is not meant to be limiting in any way. That is, whereas the term polygon typically connotes a two-dimensional shape having straight edges and angles, for the purposes of this disclosure the term includes three-dimensional shapes, and applies irrespective of the straight or arcuate nature of edges. For example ovals, spheres, cubes and pyramids are all considered to fall within the definitional scope of the term polygon. A number of examples of polygons are provided below.

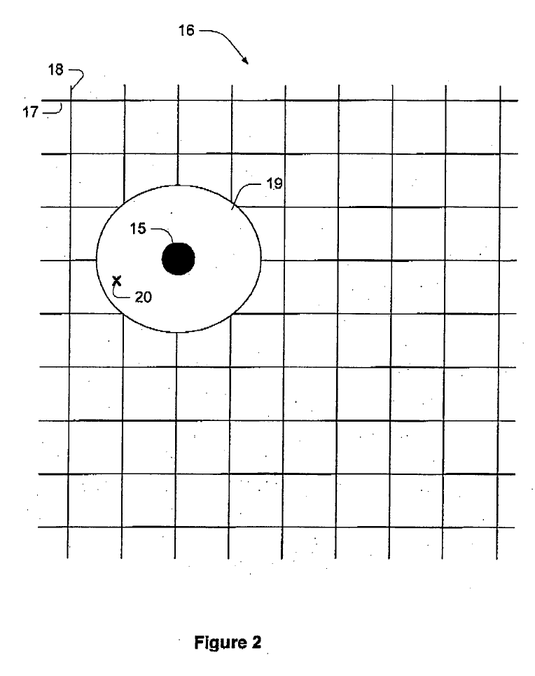

As a simple example, FIG. 2 illustrates a waypoint 15 located on a grid 16. Grid 16 includes latitude markers 17 and longitude markers 18. Grid 16 is provided for visual reference only. It will be recognised that waypoint 15 is defined by a latitude and a longitude to define a geographical position. For example, a latitude and longitude determined by a GPS module or by way of cellular telephone triangulation. Data indicative of waypoint 15 is included in an identifier “A”. Processor 10 defines for identifier “A” a polygon 19. In the present example, a circle of predetermined radius around waypoint 15 defines polygon 19. In other embodiments polygons are defined in differing manners, as discussed below. Processor 10 associates any given geographic location within polygon 19 such as position 20 with identifier “A”.

Throughout the specification, reference is made to GPS technology. Such references should not be regarded as limiting in any sense. That is, a variety of alternate technologies are used to perform locating functions. A particularly well-suited alternative to UPS is cellular telephone triangulation. Other alternatives include WIV triangulation, radar, and the like.

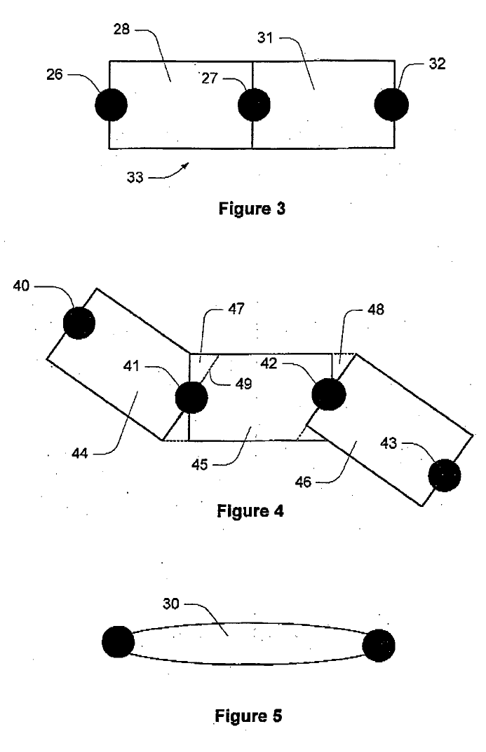

Referring to FIG. 3, waypoints 26 and 27 are illustrated, these corresponding to identifiers 6 and 7 of FIG. 1. More precisely, a graphical representation is provided of data 5 being indicative of a first identifier 6 indicative of a first waypoint 26 and a consecutive second identifier 7 indicative of a second waypoint 27. Processor 10 defines for the first identifier 6 a directional polygon 28 extending between waypoints 26 and 27.

It will be appreciated that a directional polygon is a definitional sub-class of polygon used to distinguish this particular scenario. In the present example, polygon 28 is a rectangle having opposite edges passing through waypoints 26 and 27, and an axis of symmetry connecting waypoints 26 and 27.

Processor 10 is responsive to identifier 6 for assigning a width to rectangular polygon 28. For example, in one embodiment polygon 28 represents a stretch of one side of a dual carriageway freeway having three lanes. Data indicative of the characteristic of having three lanes is included in identifier 6. Processor 10 uses this information to determine an appropriate width for polygon 28. For example, identifier 6 indicates that there are three lanes, and processor 10 uses a predetermined standard lane width multiplier to determine the width of polygon. In other embodiments identifier 6 includes data indicative of an actual road width.

Although directional polygon 28 is shown to be rectangular, alternately shaped directional polygons are considered—such as the oval directional polygon 30 of FIG. 5.

Either or both of symmetrical and non-symmetrical polygons are used in other embodiments.

Referring again to FIG. 3, data 5 is indicative of a third identifier (not shown) that is consecutive to identifier 7. This third identifier includes data indicative of a waypoint 31. Processor 10 defines for identifier 7 a rectangular directional polygon 32 extending between waypoints 27 and 31. For the sake-of the present disclosure, two or more adjacent directional polygons define a track. In this case polygons 28 and 32 define a track 33.

It will be appreciated that where a similar process is repeated for subsequent consecutive identifiers to form a string of adjacent directional polygons, a longer track is defined. In some embodiments a track includes a special identifier at a terminating end. In some cases a polygon is not defined for this identifier, whilst in other cases particular rules apply to such special identifiers.

In this embodiment, consecutive identifiers include data indicative of waypoints located along a directional passageway, such as a road. Following from this, processor generates 10 a track indicative of the passageway. To use a previous example: a side of a dual carriageway freeway. To assist in the creation of tracks, an identifier is provided for each geographical position along the passageway where the passageway undergoes greater than a threshold angular deviation, as best shown in FIG. 4. In that example, identifiers including waypoints 40 to 43 are logged by carrying a data logger along a road, For the sake of example, the data logger includes a GPS module, and takes constant readings of geographical position. The data logger is responsive to the road changing direction for logging an identifier including a waypoint identifying the approximate location of that change in direction. It will be appreciated that there will often be a slight time delay between experiencing a change in direction and the data logger being responsive to that change in direction. In some embodiments this is factored by adjusting the waypoint of a logged identifier to account for a time delay. Such an approach allows for identifiers and tracks to be automatically defied by a data logger.

FIG. 4 illustrates locations 47 where polygons 44 to 46 overlap, as well as locations 48 where polygons 44 to 46 do not provide coverage. In some embodiments a smoothing algorithm is used to alleviate this. In particular, a smoothing algorithm is used to modify the shapes of polygons 44 to 46 such that adjacent polygons share common is corner locations. In the example of FIG. 4, polygon 45 is modified to a parallelogram haying opposite edges in conformity with adjacent edges of polygons 44 and 46, as indicated by dashed line 49. In other cases trapezoids or various irregular quadrangular shapes are defined. It will be appreciated that the shape will de dependant of the angular variations involved in a particular case. Suitable smoothing algorithms will be recognised by those skilled in the art. In other embodiments various protocols are used to deal with locations 47 and 48.

Identifiers related to directional polygons are logged consecutively in tracks. For this, logger. 13 is equipped with a GPS module or other similarly functioning apparatus. Logger 13 is preferably transported along the desired track, such as a road. During this time, the GPS module takes constant readings of GPS position. Identifiers are logged both automatically and manually. In particular, if logger 13 undergoes greater than a threshold angular deviation, an identifier is automatically logged being indicative of a waypoint marking the GPS position at which the angular deviation occurred This allows a track to be automatically defined following contours of a road. In some cases a smoothing algorithm is used to reduce the number of identifiers logged around long bends or loops. Appropriate smoothing algorithms will be understood by those skilled in the art. Logger 13 is used to manually log identifier upon changes in conditions. In a simple example, a change in conditions is a change in speed limit. As logger 13 passes over a speed limit boundary, an identifier is manually logged. This identifier is indicative of a waypoint marking the OPS position of the speed limit boundary. In such embodiments, each identifier is indicative of a characteristic in the form of an applicable speed limit. In some embodiments identifiers are logged to mark out approaching objects—such as speed cameras—or regions in which specific advertising rights have been purchased.

In one embodiment, an exemplary identifier logged by such a process includes the following fields:
Identifier type—in this case directional. Sub-classes are used in some embodiments.
GPS Coordinates of waypoint.
Speed limit applicable from waypoint.
Type of street.
Name of street.
Number of lanes. Note that this applies only in the direction of travel.
Name of region.

In the above example, processor 10 uses the number of lanes field to determine the width of polygon that is to be defied. For example, an average lane width is approximately 0.6 GPS seconds. If there are two lanes in the direction of travel, processor 10 defined a rectangle being 1.2 GPS seconds wide.

In some examples an identifier includes time period fields to facilitate the inclusion of data is variable between time periods. For example, where a speed limit is X during period A and Y during period Z. End points for periods A and B are marked, and limits X and Y linked to those periods.

In some embodiments characteristics are logged when logging identifiers. In other embodiments these are logged at a later stage. In either case, an interface is typically provided to modify logged identifiers to include her characteristics or edit one or more existing characteristics.

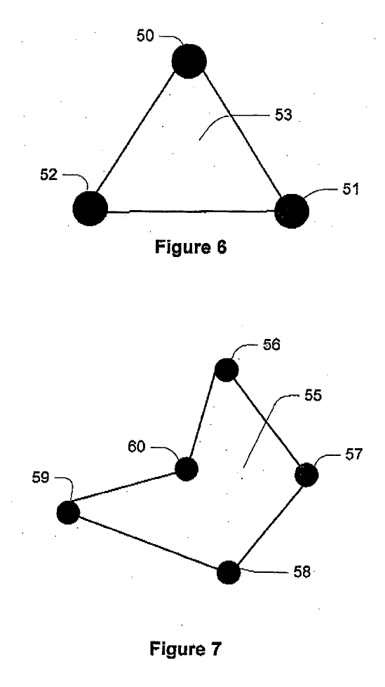

In addition to directional polygons, system 1 makes use of areal polygons. Examples are shown in FIGS. 6 and 7. For these, data 5 includes a single identifier indicative of three or more waypoints. Referring to FIG. 6, data 5 includes data indicative of waypoints 50, 51 and 52. Processor 10 defines an areal polygon 53 having a periphery 54 defined by waypoints 50, 51 and 52.

Following from the above example, an identifier indicative of an areal polygon includes the following fields:
Identifier type—in this case areal. Sub-classes are used in some embodiments.
GPS Coordinates of waypoints that define the boundary of the areal polygon to be defined.
Speed limit applicable within boundary.
Name of region.

In some cases, it is desirable to define complex areal polygons where the periphery is definable in more than one manner. For example: areal polygon 55 of FIG. 7. To achieve this, data 5 is indicative of consecutively arranged waypoints 56 to 60. These include an originating waypoint 56 and a terminating waypoint 60. Processor 10 defines areal polygon 55 having sides extending between consecutive waypoints 56 to 60 and a is side extending between waypoint 60 and the waypoint 56. It will be appreciate that other techniques are used to achieve this objective.

Identifiers indicative of areal polygons are logged similarly to identifiers indicative of directional polygons. A major difference is that a plurality of GPS specified waypoints are required for a single areal identifier. Further, there is no need to automatically log data 20 upon angular deviations. It will be appreciated that GPS data required is limited to coordinates generally marking out the region in question.

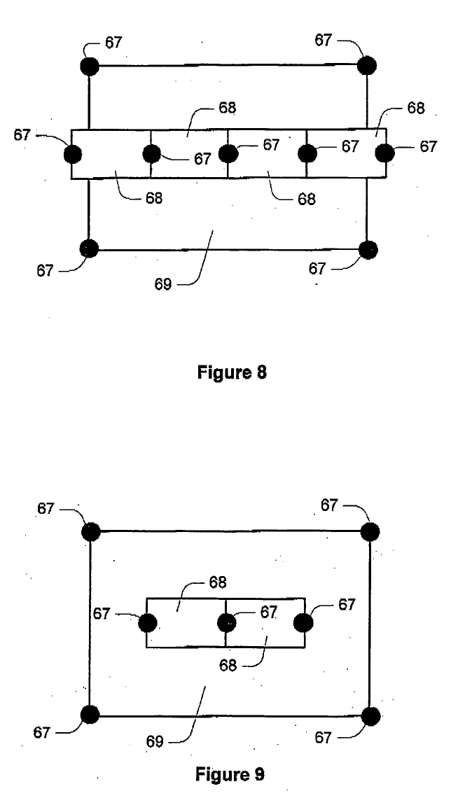

FIGS. 8 and 9 illustrate scenarios where directional polygons and areal polygons interact. In these Figures waypoints are designated by numeral 67, directional polygons by 68, and areal polygons 69. It will be recognised that in these examples directional 25 polygons or portions thereof are defined inside areal polygons. In the present embodiment, the directional polygon has priority. This approach is particularly valuable in applications directed towards mapping road and regional speed limits. A large areal polygon is used to designate a large residential area having a constant residential speed limit, and a track of directional polygons defines a major arterial road that passing though the residential area It will be appreciated that the arterial road has a higher speed limit than the rest of the area.

To recap, identifiers indicative of areal polygons and directional polygons are logged. These are logged using only a bare minimum of information. Processor 10 is responsive to this information to extrapolate polygons and effectively formulate a comprehensive information map. It is currently envisaged that, by such an approach, a database 11 indicative of one million identifiers covering a medium sized country would be the order of 20 to 80 megabytes in size. Of course, the side is dependant on detail of information stored and compression techniques. For example using alphanumeric data is more storage intensive than purely numeric data. A similar level of detail is often provided by purely numeric data if appropriate algorithms are implemented in processor 10.

Referring again to FIG. 1, embodiments are described with further attention to device 12.

Device 12 includes an interface 70 for receiving data indicative of a geographical position. In the present embodiment interface 70 includes a GPS module 71 to obtain such data, whilst in other embodiments an input for receiving data from an external UPS module is provided. In alternate embodiments the data is obtained using methods other than GPS, such as mobile phone triangulation.

In use, interface 70 receives a set of GPS coordinates, these being indicative of the geographical position of device 12. Interface 70 then communicates with processor IO to determine whether this geographical position is located within polygon defined by processor 10. Tis involves some searching, which is dealt with in greater detail below.

Where the geographical position is located within a defined polygon, interface 70 obtains data indicative of the one or more characteristics of the defining identifier.

Characteristics vary between applications. In applications where device 12 is used as an in-car information device, examples include:
A speed limit that applies in the polygon.
An upcoming speed limit that applies in an upcoming polygon, such as directional polygon on the same track as the current polygon.
An object, such as a red light camera, speed camera, toll collection booth, point of interest, or retail shop. Object based characteristics are used both for general information and advertising.
An upcoming object.
Region-specific advertising. For example, a particular company purchases exclusive advertising rights within a particular areal polygon.
A geographical name, such as a suburb, district, state, or park.
A street name for a street of which a directional polygon is indicative.

In some cases, one or more of the aspects are variable with time. For example, some areas have time variable speed limits. Further, in the case of advertising, time zones are helpful both for costing and marketing purposes. For example: peak hour on arterial roads is sold at a premium rate.

Interface 70 includes an output 72 for providing a signal indicative of one or more of the obtained characteristics. In other embodiments this output is external of interface 70, for example residing elsewhere in device 12. For example: a display on a screen of the PDA and/or a speaker for producing an audible signal. It will be appreciated that audible to signals are particularly useful in applications' directed towards assisting the blind. Device 12 is commonly used for applications such as providing location-specific (and/or direction specific) information, such as speed limits, to operators of conveyances, guiding tourists around towns, assisting blind people to locate bus stops, and so on.

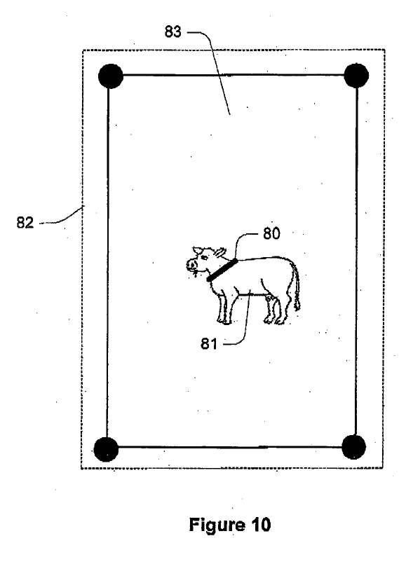

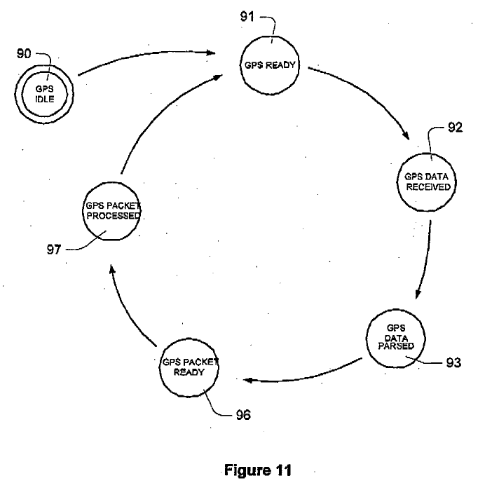

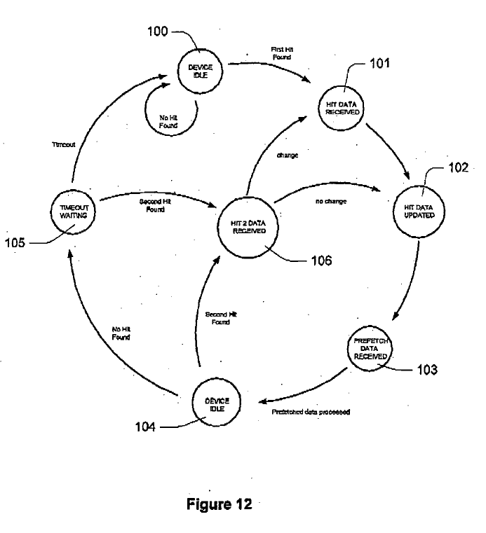

Alternate signals are used in other embodiments. In a specific application is illustrated in FIG. 10, device 12 is a collar 80 for preventing an animal 81 from leaving a predefined area 82. Area 82 represents a virtual holding pep, for example. Waypoints 83 to 85 are quantified using a GPS device. An identifier is logged including data indicative of the waypoints substantially defining the boundary of area 82. This identifier is uploaded to collar 80, which is placed on animal 81. Processor 10 defines an areal polygon 83 on the basis of the identifier. The collar takes continuous GPS readings to determine whether the collar—and the animal—is within the predefined area. Interface 70 is adapted such that if the collar leaves the predefined area, a subtle humane encouragement signal is delivered to the animal wearing the collar, this signal being designed to encourage the animal to return to the predefined area. In some embodiments concentric polygons are defined, each having a different associated signal.

FIGS. 11 and 12 respectively schematically represent the operation of GPS module 71 and device 12. It will be recognised that each of these components operate in a substantially cyclic mode. The provided examples are for illustrative purposes only, and not meant to be limiting in any way. Those skilled in the art will recognise many modifications and additions that are readily applied to the exemplary operations.

Module 71 commences in an idle configuration at 90, and is activated in response to a command at 91. GPS data is received at 92, and parsed at 93 to provide a GPS packet at 96. This packet is analysed by interface 70 at 97, which is explained by reference to FIG. 12. The CXPS device then repeats the above process.

Referring now to FIG. 12, device. 12 is idle at 100. Whilst idle, GPS packets are received from module 71 at step 97 above. These packets are analysed by interface 70 by communication with processor 10 to establish whether device 12 is with a polygon. If device 12 is found to be within a polygon, a first ‘hit’ is found. The term hit refers to an event where device 12 is found to be within a polygon. If no hit is found, the device retrains idle.

Data is obtained from processor 10 at 101 upon a hit being found. Data used by interface 70 is updated (if necessary) at 102. If the hit relates to a polygon being part of a track, data relating to one or more upcoming polygons on that track is prefetched at 103 to reduce processing times at a later stage. This is dealt with in greater detail below in relation to searching. Otherwise or subsequently, the device returns to an idle state at 104. and awaits a second hit. If no second hit is experienced, the device remains idle at 105 for is a predetermined period. Following this period the device times out and returns to the initial idle state at 100. The difference between these idle states is that at 104 and 105 a second hit is sought The practical result is that a second hit requires less processing power, as outlined further below.

If a second hit is found, the relevant data is obtained form processor 10 at 106. The second hit is either with the same or different polygon to the first hit, and data is updated accordingly.

As foreshadowed, some searching of processor 10 is necessary to determine whether OPS data from module 71 correlates to a defined polygon, and hence to an identifier, It will be appreciated that, in the case of a first hit, a large amount of data needs to be considered—that is, all polygons defined by processor 10.

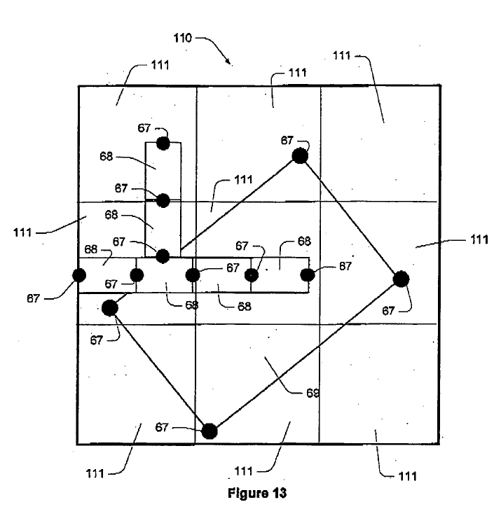

FIG. 13 schematically illustrates an embodiment where such processing is reduced. In particular, a cluster 110 is defined which defines the entirety of a mapped region. Cells 111 are defined within cluster 110. When OPS data is received by interface 70, a search begins by identifying a cell in which device 12 is located. This immediately reduces the number of polygons that are to be considered during the search. It will be appreciated that this analysis greatly reduces the amount of processing required.

It will be appreciated that in the case of a second or subsequent hit, it will not be necessary to search the entire cluster. That is, only cells proximal or including the cell identified form the first hist need be considered.

The use of tracks also reduces processing demands. Once device 12 is located on a track, the direction of travel and likely upcoming polygons are known. As such, it is possible to prefetch data for the likely upcoming polygons to reduce searching delays.

This approach is partially inspired by streaming audio from a compact disc. Alternately, tracks assist in embodiments where processor 10 only expands a portion of database 11. In particular, processor 10 need only expand sections of database 11 that relate to identifiers along a travelled path. In some embodiments cells are used for a similar purpose.

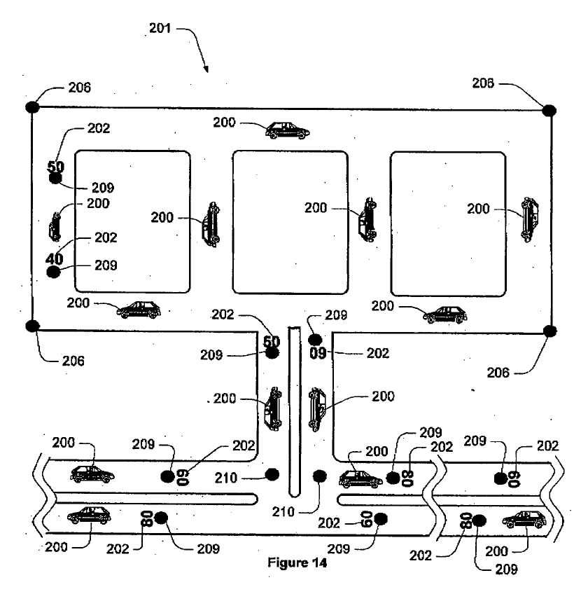

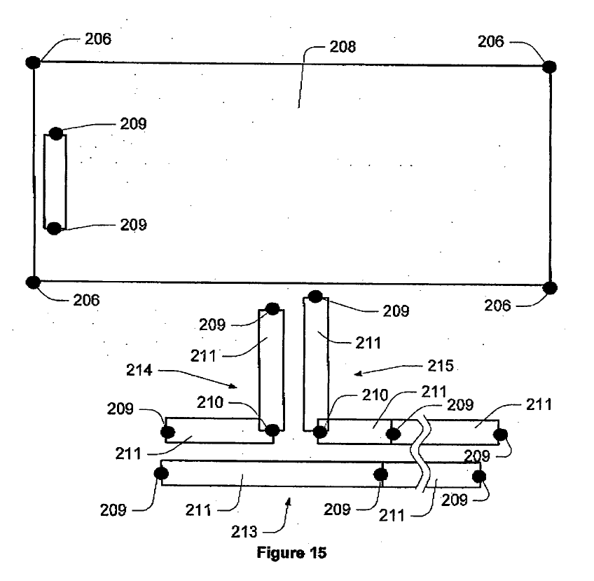

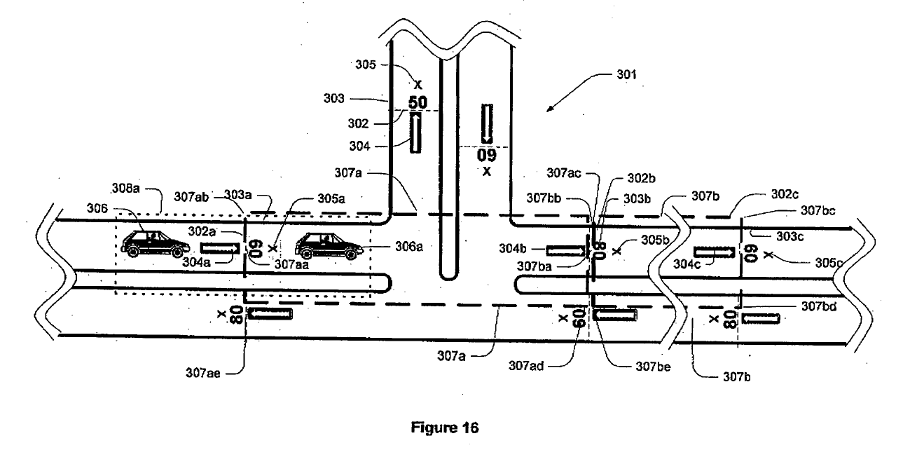

A simplified example of a specific embodiment relating to speed limits is described below with reference to FIGS. 14 and 15. In particular, FIG. 14 schematically illustrates a road network, and FIG. 16 schematically illustrates a digital map of polygons derived by processor 10. The digital map of FIG. 15 does not include smoothing algorithm effects, which are applied in some embodiments.

In this example a car 200 travels on a road network 201. Car 200 is reproduced numerous times to indicate directions of travel throughout the network. Road network 201 has a number of speed limits, marked by signs 202. System 1 is implemented on a GPS-equipped in-car apparatus (not shown) to display to an operator of car 200 the speed lit that applies at any given time, among other things.

Initially, an identifier is logged including data indicative of waypoints 206 and a 50 km/h speed limit This marks out area 207, which is a residential zone with a 50 km/h speed limit. Processor 10 is responsive to this identifier for defining an areal polygon 208. A data logger is transported around the road network log identifiers and tracks. Identifiers are manually logged for waypoints 209 which indicate changes in speed zones, and automatically logged for identifiers 210 to factor angular deviations. Each of these identifiers is logged along with data indicative of the applicable speed limit in the polygon that is to be defined. Processor 10 defines directional polygons 211 for these identifiers.

As car 200 travels around network 2, the GPS module provides continuous readings and the in-car device experiences hits with various polygons 208 and 211. In response, the in-car device conveys an applicable speed limit to the operator of car 200. It will be recognised that three tracks 213, 214 and 215 are defined.

It will be appreciated that this is a simplified example, and in more complicated examples more identifiers are used to indicate speed limit warning zones, and the like. A more complex example is set out below. Although the below example uses some differing techniques and terminology to those above, those skilled in the are will readily recognise s how the teachings are cross-correlated.

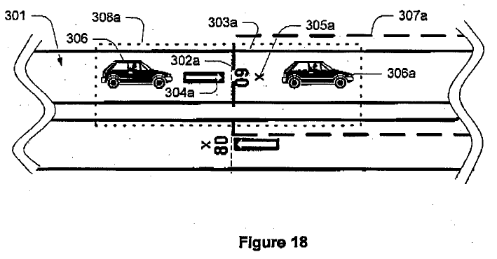

The following embodiment is described with general reference to FIGS. 16, 17 and 18 as applying to an in car speed limit information apparatus (in-car apparatus) for the driver of car 6, 306a, 306d, 306e on road network 301.

The in car apparatus includes a means of retrieving the relevant speed limit 303a, 3b, 3c, 3d, 3e, 310a from a database of information (the ‘speed limit database’) that applies to car 306, 306a, 306d, 306e according to its instant position and its instant direction and according to the instant time, day and date as the car 306, 306a, 306d, 306e moves along road network 301. Additionally the in car apparatus preferably includes a means of retrieving an upcoming speed limit 303a in the figures according to the instant time, day is and date as car 306 moves along road network 301.

Tho speed limit database can be stored in car 306 with the apparatus or remotely of the car 306 when in wireless communication with the apparatus.

The in car apparatus also includes a global positioning system (OPS) receiver that can determine the instant position of the car 306 and determine the instant direction the car 306 is moving and determine the instant time, day, date and track the same. The instant OPS positional data includes at least the latitude and longitude coordinates of car 306.

The in car apparatus uses the instant positional and time data to refer to the speed limit database to retrieve the relevant speed limit 303a, 303b, 303c, 303d, 303e, 310a, that applies according to the instant parameters, which is presented to the driver of car 306 for information on the instant applicable speed limit 303a, 303b, 303c, 303d, 303e, 310a.

Additionally the in car apparatus uses the instant positional and time data to refer to the speed limit database to detect an upcoming speed limit 303a as shown in the figures in the case of car 306 and if the upcoming speed limit 303a that is-detected is lower than the instant speed limit of car 306 a warning is presented to the operator of car 306 before car 306 reaches the lower speed limit 303a.

Advantageously as car 306 travels and the applicable speed limit 303 (generally) changes the speed limit presented to the operator will be updated by the in car apparatus as the GPS receiver tracks the instant position and direction of the car, and the instant time, day, date, and on a change of instant speed limit 303, an audible alarm (or other sensory alarm) is preferably set off to ensure the driver is alerted to a change of instant speed limit 303.

Advantageously as car 306 travels and upcoming speed limit 303a as shown in the figures in the case of car 306 is detected and it is determined to be lower than the instant speed limit of car 306 an audible alarm (or other sensory alarm) is preferably set off to ensure the driver is alerted to upcoming lower speed limit. Of course an upcoming speed limit 303a that is detected to be greater than the instant speed limit of car 306 can also be communicated to the driver to give them a forewarning that an increased speed limit zone may be coming up.

Optionally the in car apparatus may also cooperatively interact with the car speed control system as the speed limit 303 changes and or the existence of an upcoming lower speed limit is detected, for example to change the target setting of an in car speed cruise control.

Advantageously, the time, day, date information provides a means of discriminating the speed limits that apply in variable speed zones such as a school zone from fixed speed zones.

The speed limit database includes a compilation of vector polygon-records, warning zone records and area polygon records that apply to road network 301.

Each vector polygon record is compiled by logging the position being at least the latitudinal and longitudinal coordinates of a speed limit waypoint 302a, 302b, 302c, 302d along road network 301, wherein each waypoint 302a, 302b, 302c, 302d is illustrated as an ‘X’ in FIGS. 16 & 17. Additionally with each speed limit waypoint 302a, 302b, 302c, 302d in the vector polygon record the following are logged:

a corresponding speed limit 303a, 303b, 303c, 303d;

corresponding time, day and date data which particularize the times, days and or dates during which the corresponding speed limit 303a, 303b, 303c, 303d applies;

the position being at least the latitudinal and longitudinal coordinates of a corresponding directional waypoint 305a, 305b, 305c, 305d wherein each waypoint is illustrated as an ‘X’ in FIGS. 16 & 17 and wherein directional waypoint 305a, 305b, 305c, 305d is a designated minimum distance from corresponding speed limit waypoint 302a, 302b, 302c, 302d and in a direction along road network 301 that car 306 travels as illustrated generally by corresponding road direction markers 304a, 304b, 304c, 304d;

a direction reference (not shown) calculated from each corresponding pair of speed limit 302a, 302b, 302c, 302d and directional 305a, 305b, 305c, 305d waypoints wherein s the direction reference includes a designated maximum angular tolerance relative to the absolute direction from speed limit waypoint 302a, 302b, 302c, 302d to corresponding directional waypoint 305a, 305b, 305c, 305d;

the position being at least the latitudinal and longitudinal coordinates of nodes [7aa, 307ab, 307ac, 307ad, 307ae], [7ba, 307bb, 307bc, 307bd, 307be], [7da, 307db; 307dc, lo 307dd, 307de] of a direction polygon 307a, 307b, 307d that is symmetrical [a direction polygon for speed limit waypoint 302c is not shown in FIGS. 15 or 16] and wherein at least a portion of the area encompassed by direction polygon 307a, 307b, 307d is representative of and includes at least a portion of the area of road network 301 between speed limit waypoint 302a, 302b, 302d and at least one other speed limit waypoint 302, for is example in the case of speed limit waypoint 302a the at least one other speed limit waypoint is speed limit waypoint 302b, in the case of speed limit waypoint 302b the at. least one other speed limit waypoint is speed limit waypoint 302c, and in the case of speed limit waypoint 302d the at least one other speed limit waypoint is speed limit waypoint 302e.

the axis of symmetry (not shown) is substantially parallel to or coincident with a linear line extending between speed limit waypoint 302a, 302b; 302d and the corresponding at least one other speed limit waypoint 302b, 302c, 302e.

A speed limit warning zone shown as a polygon 308a in the figures is logged for each speed limit waypoint 302, where polygon 308a corresponds to speed limit waypoint 302a in the figures (speed limit warning zone polygons are not shown in the figures for speed limit waypoints 302b, 302c, 302d).

The warning zone need not be a polygon 308a but may be any shape including a circle, part circle, ellipse or any other shape as long as the speed limit waypoint 302 that corresponds with the waning zone is within or on the boundary of the area encompassed by the warning zone, and at least a portion of the area encompassed by the warning zone is representative of and includes at least a portion of the area of road on approach to the corresponding speed limit waypoint 302 along road network 301, as shown in the case of polygon 8a in relation to speed limit waypoint 302z.

Each area polygon record is compiled by logging records of the position being at least the latitudinal and longitudinal coordinates of nodes 309a, 309b, 309c, 309d, 309e of a speed limit area polygon 309 and a corresponding speed limit 310a for area polygon 309a wherein the area encompassed by each area polygon 309a is representative of and includes the area of a plurality of roads 31 a in a road network 301 portion having a common speed limit 310a.

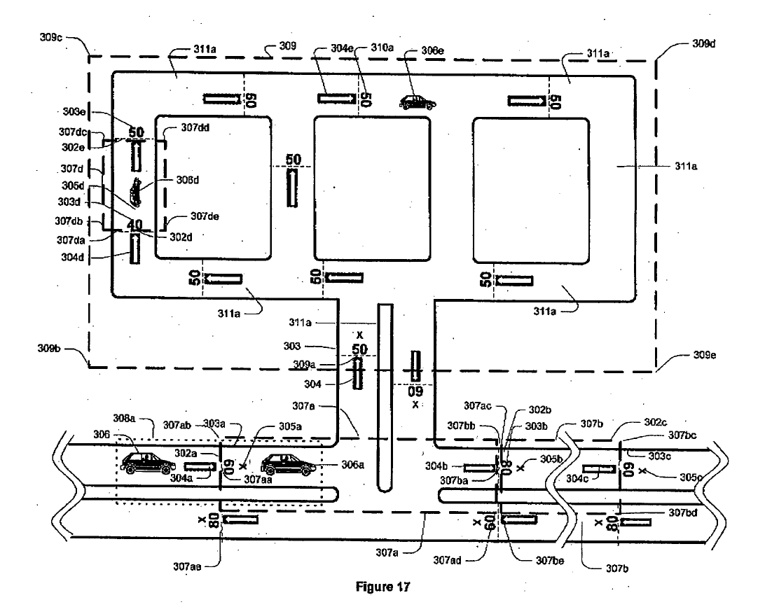

Area polygon 309 in FIG. 17 is shown to include within its area, a direction polygon 307d which represents a variable speed school zone that applies during particular lime periods on particular days.

The instant speed limit communicated to the operator is determined by determining the instant:

position of car 306, being at least the latitudinal and longitudinal coordinates of car 306 direction car 306 is moving; and

time, day and date that applies when the instant position of car 306 and or the instant direction is determined; then if

the determined position is within the area encompassed by a direction polygon 307a, 307b, 307d; and

the determined instant direction is within the direction reference corresponding with speed. Init waypoint 302a, 302b, 302d that corresponds with direction polygon 307a, 307b, 307d; and

the determined instant time, day and date that applies is within the corresponding time, day and date data that apply to direction polygon 307a, 307b, 307d; then

the speed limit communicated to the operator is speed limit 303a, 303b, 303c, 303d corresponding to speed limit waypoint 302a, 302b, 302d;

otherwise if

the determined position is within the area encompassed by a speed limit area polygon 309 then the speed limit communicated to the operator is speed limit 310a corresponding to speed limit area polygon 309; then

a default speed limit warning message is communicated instead of the instant speed limit.

In the case of car 306a travelling in direction 304a the instant speed limit communicated to the driver of car 306a is ‘60’ being the speed limit 303a corresponding with direction polygon 307a and speed limit waypoint 302a.

In the case of car 306a travelling in direction 304a the instant speed limit communicated to the driver of car, 306a is ‘60’ being the speed limit 303a corresponding with direction polygon 307a and speed limit waypoint 302a.

In the case of car 306e travelling in direction 304e the instant speed limit communicated to the operator of car 306e is ‘50’ being the speed limit 310a corresponding with area polygon 309.

In the case of car 306d travelling in direction 304d the instant speed limit communicated to the operator of car 306d is contingent on the instant time, day or date that applies when car 306d is within the area of direction polygon 307d and is either ‘40’ being the speed limit 303d corresponding with direction polygon 307d and speed limit waypoint 302d or is ‘50’ being the speed limit 310a corresponding with area polygon 309.

The speed limit warning communicated to the operator is determined by:

determining if the at least the instant latitude and longitude position of car 306 is within the area encompassed by a warning zone such as polygon 308a; and if

the determined at least the instant latitude and longitude position is within the area encompassed by a warning zone 308a; then

the speed limit warning communicated to the operator is the speed limit 303a corresponding to the speed limit waypoint 302a corresponding to the warning zone 308a;

otherwise

no speed limit warning is communicated or a default message is communicated such as ‘no upcoming lower speed limit zones detected’.

In the case of car 306, its instant latitude and longitude position is within the area encompassed by a warning zone polygon 308a therefore an upcoming speed limit 303a is detected as corresponding with speed limit waypoint 302a which corresponds with warning zone polygon 308a then the upcoming speed limit 303a which is ‘60’ is presented to the driver of car 306 as a warning of an upcoming speed limit otherwise no speed limit warning is communicated or a default message is communicated such as ‘no upcoming speed limit zones detected’.

The speed limit waypoints 302a, 302b, 302c, 302d and corresponding directional waypoints 305a, 305b, 305c, 305d during compilation of the speed limit database are logged by:

cooperatively interconnecting a GPS receiver to a data acquisition apparatus so that the instant global position indicated by the GPS receiver being at least the latitude and longitude coordinates can on demand be logged on the data: acquisition apparatus against a waypoint generally shown as 302 in the figures;

Travelling with the global positioning receiver and the data acquisition apparatus along road network 301 and when a speed limit indicator generally shown as 303 in the figures is encountered commanding the data acquisition apparatus to sample and log the instant global position indicated by the GPS receiver creating a speed limit waypoint 302 while continuing with the travel in direction generally shown as 304 in the figures being the direction of travel along the road network 301 when passing the waypoint 302 to which speed limit indicator 303 applies;

data inputting into the data acquisition apparatus against the speed limit waypoint 302 at least the speed limit indicated by the speed limit indicator 303, and time, day and date data in which the speed limit 303 applies;

allowing the data acquisition apparatus to automatically sample and log the instant global position information indicated by the GPS receiver being at least the latitude and longitude coordinates after a set time for example 303 seconds from when the speed limit waypoint 302 was logged, and log the newly sampled global position information as a direction waypoint generally shown as 305 in the figures associated with the speed limit waypoint 302.

Advantageously if the altitude is logged with all the other GPS positional data for the waypoints, nodes of polygons, and the instant position of car 306 then that provides another means of discriminating which area or direction polygon applies to the instant position and direction of the car, and therefore which speed limit applies to the car 306 in situations wherein one road section is above another road section and cars 306 are travelling in the same direction as my be the case in some road networks and interchanges.

Advantageously directional polygons and the position of their respective nodes which apply on linear sections of road having multiple speed limit waypoints on the same linear section can be calculated by modelling techniques using the positional and directional and other information logged with the corresponding speed limit waypoints.

Similarly warning zone polygons and the position of their respective nodes can be calculated by modelling techniques using the positional and directional and other information logged with the corresponding speed limit waypoints.

For example when a speed limit waypoint 302a, 302b, 302c, 302d is logged the number of lanes on the road to which the speed limit applies is also logged. Successive pairs of speed limit waypoints such as 302a & 302b, 302b & 302c on the linear section of road are identified so the respective direction polygons can be advantageously calculated by modelling techniques. Then a rectangular direction polygon 307a, 307b is constructed by having a rectangular width of at least equal to the number of lanes logged against the respective speed limit waypoint 302a, 302b multiplied by the nominal width of a traffic lane say 303 meters, and a rectangular length of the polygon 307a, 307b is mapped to extend between the respective successive pairs of speed limit waypoints such as 302a & 302b, 302b & 302c and the polygon 307a, 307b is mapped so that its longitudinal axis of symmetry coincides with a linear line between the relevant pair of speed limit waypoints such as 302a & 302b, 302b & 302c. In this way a direction polygon such as 307a, 307b can easily be modelled and its nodes calculated and logged against the 3020 corresponding speed limit waypoint 302a, 302b.

Similarly rectangular warning zone polygons such as 308a can be constructed about each speed limit waypoint, and as shown in the case of polygon 308a with corresponding speed limit waypoint 302a . A rectangular warning zone polygon 308a is constructed by having a rectangular width of at least equal to the number of lanes logged against the respective speed limit waypoint 302a, multiplied by a nominal width of a traffic lane, and a rectangular length of the polygon 308a can be calculated as a function of the speed limit 303a that corresponds with the corresponding waypoint 302a.

For example the polygon length may be the speed limit in km/hour multiplied by a factor of two and the result representing the length of the warning zone polygon in meters.

In the case of polygon 308a its length is speed limit 303a ‘80’ (being 80 km/hour) multiplied by ‘2’ giving a polygon 308a length of 160 meters.

The rectangular polygon 308a is mapped so its centre coincides with the corresponding speed limit waypoint 302a and the longitudinal axis of symmetry of polygon 308a coincides with the longitudinal axis of symmetry of the rectangular direction polygon 307a that corresponds to the speed limit waypoint 302a. In this way a warning zone polygon 308a can easily be modelled and its nodes calculated and logged against the corresponding speed limit waypoint 302a.

Alternatively direction polygons, warning zone polygons, and area polygons can be mapped using survey techniques using the positional and directional and other information is logged with the corresponding speed limit waypoints. For example the speed limit waypoints may be marked onto an aerial map of the road network 301 having latitude and longitude grind references. Then the polygons can be manually constructed on the map between successive speed limit waypoints and the nodes of each polygon ascertained from the aerial map logged against the respective speed limit waypoint of occurs there are other survey techniques that may be applied.

Although the invention has been described with reference to a specific example, it will be appreciated by those skilled in the art that the invention may be embodied in many other forms.

1. An information system including:
an input for receiving data indicative of one or more consecutive identifiers, each identifier including data indicative of at least one geographical waypoint; and
a processor responsive to the data for defining for each identifier a respective polygon indicative of a geographical region such that any given geographical position within the polygon is associated with the defining identifier.

2. A system according to claim 1 wherein each polygon has one or more characteristics and the defining identifier includes data indicative of the one or more characteristics.

3. A system according to claim 1 wherein the data is indicative of a first identifier indicative of a first waypoint and a consecutive second identifier indicative of a second waypoint, and the processor defines for the first identifier a directional polygon extending between the first and second waypoints.

4. A system according to claim 3 wherein the directional polygon has an axis of symmetry connecting the first and second waypoints.

5. A system according to claim 3 wherein the directional polygon is a rectangle having opposite edges passing through the first and second waypoints.

6. A system according to claim 5 wherein the processor is responsive to the first identifier for assigning a width to the rectangle.

7. A system according to claim 3 wherein the data is further indicative of a third identifier that is consecutive to the second identifier, and the processor defines for the second identifier a directional polygon extending between the second and third waypoints.

8. A system according to claim 7 wherein two or more adjacent directional polygons define a track.

9. A system according to claim 8 wherein consecutive identifiers include data indicative of waypoints located along a directional passageway to such that the processor generates a track indicative of the passageway.

10. A system according to claim 9 wherein an identifier is provided for each geographical s position along the passageway where the passageway undergoes greater than a threshold angular deviation.

11. A system according to claim 1 wherein the data includes a single identifier indicative of three or more waypoints and the processor defines an areal polygon having a periphery defined by the three or more waypoints.

12. A system according to claim 1 wherein the data includes an identifier indicative of three or more consecutively arranged waypoints including an originating waypoint and a terminating waypoint, and the processor defines an areal polygon having sides extending between consecutive waypoints and a side extending between the originating waypoint and the terminating waypoint.

13. A system according to claim 2 including an interface for receiving data indicative of a geographical position, the interface being in communication wit processor for:
determining whether the geographical position is located within a defined polygon; and
where the geographical position is located within a defined polygon, obtaining data indicative of the one or more characteristics of the defining identifier.

14. A system according to claim 13 wherein the interface receives data indicative of a geographical position from a GPS module.

15. A system according to claim 13 including an output for providing a signal indicative of one or more of the obtained characteristics.

16. A system according to claim 2 wherein the characteristics include any one or more of the following:
a speed limit;
an upcoming speed limit;
an object;
an upcoming object;
region-specific advertising;
a geographical name; and
a street name.

17. A system according to claim 16 wherein one or more of the characteristics are variable with time.

18. A system for logging geographical information, the system including:
a data logger for defining one or more consecutive identifiers, each identifier including data indicative of at least one geographical waypoint the identifiers being processable to define for each identifier a respective polygon indicative of a geographical region such that any given geographical position within the polygon is associated with the defining identifier.

19. A method for logging geographical information including the steps of:
consecutively: logging one or more geographical waypoints; and
generating one or more identifier including data indicative of the one or more geographical waypoints such that the identifiers are processable to define for each identifier a respective polygon indicative of a geographical region such that any given geographical position within the polygon is associated with the defining identifier.

20. A system for storing information, the system including:
a database for receiving and storing one or more consecutive identifiers, each identifier including data indicative of at least one geographical waypoint the identifiers 23 being processable to define for each identifier a respective polygon indicative of a geographical region such that any given geographical position within the polygon is associated with the defining identifier.
